(19) United States
(12) Patent Application Publication
(10) Pub. No.: US 2010/0106765 A1
(43) Pub. Date: Apr. 29, 2010

(54) INFORMATION PROVIDING METHOD AND SYSTEM THEREFOR

(75) Inventors: Motonobu Saito, Kawasaki (JP); Sachio Minami, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/507,495

(22) Filed: Jul. 22, 2009

(30) Foreign Application Priority Data
Oct. 20, 2008 (JP) 2008-269317

(51) Int. Cl. G06F 15/16; G06F 17/30; G06F 7/06

(52) U.S. Cl. 709/202; 707/E17.014; 707/E17.032

(57) ABSTRACT

A notification apparatus transmits notification-related information (a notification message and a notification target(s)) to a notification-related information guarantee apparatus, and the notification-related information guarantee apparatus guarantees that the notification-related information has been received from nothing other than the notification apparatus. After the notification apparatus transmits the notification-related information guaranteed authentic to an intermediary notification apparatus, the intermediary notification apparatus also confirms whether the notification-related information has been guaranteed authentic by the notification-related information guarantee apparatus. If the notification-related information is confirmed to have been guaranteed authentic, then, the intermediary notification apparatus acquires from multiple owner-information management apparatuses the owner information (an owner name(s) and contact information) that corresponds to the notification target(s) (one or more item IDs). Thereafter, the intermediary notification apparatus notifies the notification target(s) of the notification message with the use of the owner information and transmits the notification result to the notification apparatus.

### BACKGROUND OF THE INVENTION

The present invention relates to information-processing-based technologies for assistance in notifying the owners or managers of items such as products and the like of information related to the items.

Recent years have seen a series of product recalls, forcing many manufacturers to spend much time and effort on getting recalled products back. One of the reasons that product recalls impose such a large burden on manufacturers is that the manufactures are often unable to know exactly who the owners of their products are. Since product recalls are now prevalent including recalls of the products that have devastating influences on one's body and life, manufacturers will be obliged to notify the owners of particular products of the need for inspection in due time for the purpose of encouraging inspection. Thus, the need for manufacturers to know the owners of their products will become more urgent.

For manufacturers to know the owners of their products, the manufacturers need to have their product purchasers fill in and post customer registration forms in advance or have their retailers disclose purchaser information. However, the former method is not quite promising because the purchasers are unlikely to bother to do so. The latter method is not promising, either, because the retailers cannot or are reluctant to disclose such information due to the trend toward personal information protection.

Such being the situation, U.S. Patent Application No. 2007/0026875 discloses a method and apparatus that allow an event notifier (corresponding to a manufacturer) to notify service users (corresponding to product owners) of event notification messages (corresponding to information concerning product recalls and product inspection) even if the service users do not disclose their contact information to the event notifier. More specifically, this is achieved by a proxy server (relay agent) managing combinations of message IDs and contact information, receiving a message ID and a message from a proxy request device (event notifier), and transmitting the message to the service users with the contact information that corresponds to the message ID.

### SUMMARY OF THE INVENTION

When combinations of message IDs and contact information are managed by multiple or a great number of relay agents (corresponding to retailers in the above-mentioned product-recall and product inspection case), notifiers have so far been required to examine which relay agent is the best way to notify their notification recipients.

One of the problems that the present invention faces is that notifiers need to make business contracts with a number of relay agents, and the notifiers thus need to incur enormous costs associated with the notification relay services. Considering the notifiers and the relay agents in terms of the manufacturer-retailer relationship (the notifiers being the manufacturers and the relay agents being the retailers), it can be easily imaged how laborious notification tasks are. When, on the other hand, the relay agents are assumed to be separate entities from the retailers, a possible case may be one in which each of the relay agents acquires combinations of message IDs and contact information from all the retailers in advance and manages them in a unified manner. However, the retailers are inclined to disclose personal information such as customer contact information and the like only when absolutely necessary and reluctant to disclose such information when the retailers are not sure of when such information is necessary for the relay agents. In addition, the relay agents are reluctant to incur storage costs and information leakage risks resulting from having a great amount of personal information as to which the relay agents themselves are not sure of when such information is necessary.

An object of the invention is thus to provide an information providing system which allows notifiers to efficiently transmit notification messages to the notification recipients with the contact addresses (including domiciles, e-mail addresses, and phone numbers) that correspond to particular item IDs even if the notifiers are not aware of the contact addresses that correspond to the particular item IDs and even if combinations of item IDs and contact information are managed by a number of separate parties (or entities). Another object of the invention is to provide an information providing system which is acceptable to the notification recipients in terms of personal information protection. Still another object of the invention is to provide an information providing technology which is capable of exercising control such that only appropriate notification is allowed to be performed for the notification recipients.

Thus, the invention is designed to allow an intermediary apparatus to receive the owner information (such as domiciles and the like) possessed by service providers (service provider apparatuses) that practice selling or the like of items (including products) and to control such information in a unified manner. This is equivalent to the statement that the contact information possessed by each of the service provider apparatuses is transmitted via the intermediary apparatus to the apparatuses of notifiers.

This makes it possible for the notifiers to notify each of the owners of items of particular item-related information without knowing the personal information of the owners such as their names or their contact information. It should be noted that the invention embraces a configuration in which the notifiers are allowed to know such contact information.

Specifically, the invention is configured as below. In one aspect, the invention is a first notification method for mediating notification from a notification apparatus to the owners of items, the first notification method involving the use of an information processing apparatus that comprises arithmetic processing means, storage means, and communication means, the first notification method comprising the steps of the arithmetic processing means:

acquiring from the notification apparatus via the communication means a combination(s) of a notification message and the item ID(s) of one or more items for which the notification apparatus requests mediation of notification to the owner(s) of the one or more items;

storing the combination(s) on the storage means;

acquiring the owner information corresponding to the item ID(s) via the communication means from an owner-information management apparatus that stores and manages the owner information;

storing on the storage means a combination(s) of the item ID(s) and the owner information;

acquiring from the storage means the owner information corresponding to the item ID(s) and the notification message corresponding to the item ID(s);

transmitting the notification message corresponding to the item ID(s) to the owner(s) with the use of the owner information corresponding to the item ID(s); and

transmitting the notification results of the one or more items for which the notification apparatus requested mediation of notification to the owner(s) via the communication means.

In another aspect, the invention is a second notification method for mediating notification from a notification apparatus to the owners of items, the second notification method involving the use of an information processing apparatus that comprises arithmetic processing means, storage means, and communication means, the second notification method comprising the steps of the arithmetic processing means:

acquiring from the notification apparatus via the communication means a combination(s) of a notification message and the item ID(s) of one or more items for which the notification apparatus requests mediation of notification to the owner(s) of the one or more items;

requesting via the communication means a contact-information guarantee apparatus that guarantees the authenticity of the information on the combination(s) to confirm whether the information on the combination(s) is guaranteed authentic or not;

storing the combination(s) on the storage means if the information on the combination(s) is guaranteed authentic by the contact-information guarantee apparatus;

acquiring the owner information corresponding to the item ID(s) via the communication means from an owner-information management apparatus that stores and manages the owner information;

storing on the storage means a combination(s) of the item ID(s) and the owner information;

acquiring from the storage means the owner information corresponding to the item ID(s) and the notification message corresponding to the item ID(s);

transmitting the notification message corresponding to the item ID(s) to the owner(s) with the use of the owner information corresponding to the item ID(s); and

transmitting the notification results of the one or more items for which the notification apparatus requested mediation of notification to the owner(s) via the communication means.

In still another aspect, the invention is a notification mediation requesting method for requesting an information processing apparatus to mediate notification to the owners of items, the method involving the use of a notification apparatus that comprises arithmetic processing means, storage means, and communication means, the method comprising the steps of the arithmetic processing means:

storing on the storage means a combination(s) of a notification message and the item ID(s) of one or more items for which the notification apparatus requests mediation of notification to the owner(s) of the one or more items;

requesting via the communication means a contact-information guarantee apparatus that guarantees the authenticity of the information on the combination(s) to confirm whether the information on the combination(s) is guaranteed authentic or not;

transmitting the combination(s) via the communication means to the information processing apparatus if the information on the combination(s) is guaranteed authentic by the contact-information guarantee apparatus, thus requesting the information processing apparatus to mediate notification to the owner(s) of the one or more items;

acquiring the notification results of the one or more items for which the notification apparatus requested mediation of notification to the owner(s) from the information processing apparatus via the communication means; and

storing the notification results of the one or more items on the storage means.

In still another aspect, the invention is a contact-information guarantee method for guaranteeing the authenticity of the information a notification apparatus uses to request an information processing apparatus to mediate notification to the owners of items, the method involving the use of a contact-information guarantee apparatus that comprises arithmetic processing means, storage means, and communication means, the method comprising the steps of the arithmetic processing means:

acquiring the information from the notification apparatus via the communication means;

storing the information on the storage means to guarantee the authenticity of the information;

acquiring from the information processing apparatus via the communication means a confirmation request for the contact-information guarantee apparatus to confirm whether contact information that includes a combination of an item ID and a notification message is authentic or not; and

notifying the information processing apparatus via the communication means that the contact information is guaranteed authentic if the combination is stored on the storage means and that the contact information is not guaranteed authentic if the combination is not stored on the storage means.

Other problems, the present invention is to disclose and solutions thereto will become apparent upon consideration of the following detailed description of preferred embodiments and the accompanying drawings.

In accordance with the invention, the owners of items can be notified more efficiently of information related to the items.

### BRIEF DESCRIPTION OF THE DRAWINGS

FIG. 1 is a diagram illustrating the overall configuration of a system according to preferred embodiments of the invention.

FIG. 2 is a diagram illustrating the configuration of a storage device that is included in an owner-information management apparatus.

FIG. 3 is a diagram illustrating the configuration of a storage device that is included in a notification apparatus.

FIG. 4 is a diagram illustrating the configuration of a storage device that is included in an intermediary notification apparatus.

FIG. 5 is a diagram illustrating the configuration of a storage device that is included in a notification-related information guarantee apparatus.

FIG. 6 is a flowchart illustrating the process flows of notification mediation operation, notification-related-information guarantee-status response operation, and owner-information response operation.

FIG. 7 is a flowchart illustrating the process flows of notification operation, and notification-related-information guarantee operation.

### DESCRIPTION OF THE PREFERRED EMBODIMENTS

Preferred embodiments of the invention will now be described with reference to the accompanying drawings.

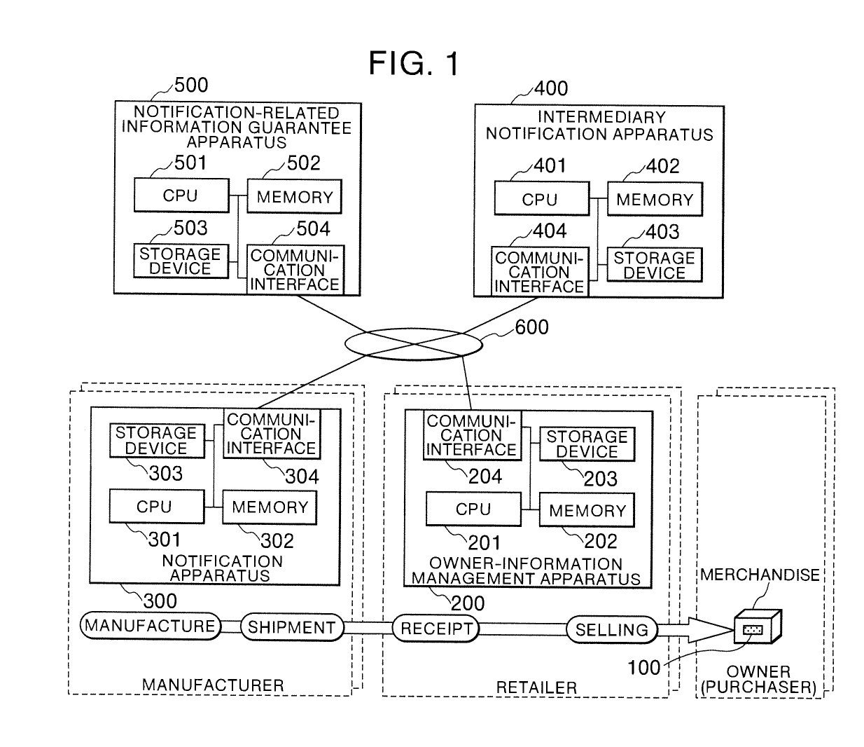

FIG. 1 is a diagram illustrating the overall configuration of a system according to the preferred embodiments of the invention. The diagram illustrates a notification-related information guarantee apparatus 500; an intermediary notification apparatus 400; a notification apparatus 300, which is provided at least for each manufacturer; an owner-information management apparatus 200, which is provided at least for each retailer; an item ID 100, which is assigned to a purchased product a customer owns (for the sake of simplicity, only one item ID 100 is shown); and a communication channel 600. The communication channel 600 connects together the notification-related information guarantee apparatus 500, the intermediary notification apparatus 400, the notification apparatus 300, the owner-information management apparatus 200, and the like.

The communication channel 600 is, for example, one that meets the standards of wired LANs, wireless LANs, or the like.

The item ID 100 is data stored on such a medium as a barcode, a two-dimensional code, and an RFID tag and is used to identify the single and unique product to which the medium with the item ID 100 is attached in such a manner as to distinguish between purchased products of the same type.

The owner-information management apparatus 200 is, for example, an information processing device such as a PC and the like. The owner-information management apparatus 200 manages information on purchasers (or owners) which is obtained from the purchasers on a product-by-product basis. The owner-information management apparatus 200 also receives a request for the owner information of particular products from the intermediary notification apparatus 400 and responds with the requested owner information. The owner-information management apparatus 200 structurally includes at least a CPU 201, a memory 202, a storage device 203, and a communication interface 204. The communication interface 204 is, for example, a wired LAN card, a wireless LAN card, or the like and communicates with the intermediary notification apparatus 400 via the communication channel 600. The storage device 203 is, for example, one that stores programs and data and more specifically a hard disk drive, a flash memory, or the like. The programs above are read by the memory 202 and executed by the CPU 201, thereby performing particular tasks. The owner-information management apparatus 200 also includes a reader capable of reading the information contained in an RFID tag or the like attached to a product. The owner-information management apparatus 200 may not necessarily include that reader as long as the owner-information management apparatus 200 is provided with the requirements that enable input of the item ID 100 into the owner-information management apparatus 200.

The notification apparatus 300 is, for example, an information processing device such as a PC and the like. To notify the owners of products sold of particular information, the notification apparatus 300 requests the notification-related information guarantee apparatus 500 to guarantee the authenticity of notification-related information and requests the intermediary notification apparatus 400 to act as an intermediary in notifying the owners. The notification apparatus 300 structurally includes at least a CPU 301, a memory 302, a storage device 303, and a communication interface 304. The communication interface 304 is, for example, a wired LAN card, a wireless LAN card, or the like and communicates with the intermediary notification apparatus 400, the notification-related information guarantee apparatus 500 via the communication channel 600. The storage device 303 is, for example, one that stores programs and data and more specifically a hard disk drive, a flash memory, or the like. The programs above are read by the memory 302 and executed by the CPU 301, thereby performing particular tasks.

The intermediary notification apparatus 400 is, for example, an information processing device such as a PC and the like. Receiving a notification mediation request from the notification apparatus 300, the intermediary notification apparatus 400 requests the notification-related information guarantee apparatus 500 to verify the notification-related information included in that request, acquires the owner information of particular products from the owner-information management apparatus 200, and acts as an intermediary in notifying the owners of the products. The intermediary notification apparatus 400 structurally includes at least a CPU 401, a memory 402, a storage device 403, and a communication interface 404. The communication interface 404 is, for example, a wired LAN card, a wireless LAN card, or the like and communicates with the owner-information management apparatus 200, the notification apparatus 300, and notification-related information guarantee apparatus 500 via the communication channel 600. The storage device 403 is, for example, one that stores programs and data and more specifically a hard disk drive, a flash memory, or the like. The programs above are read by the memory 402 and executed by the CPU 401, thereby performing particular tasks.

The notification-related information guarantee apparatus 500 is, for example, an information processing device such as a PC and the like. The notification-related information guarantee apparatus 500 guarantees, after receiving a request from the notification apparatus 300, the authenticity of the notification-related information included in the request and also verifies, after receiving a request from the intermediary notification apparatus 400, the notification-related information included in the request and responds with the result. The notification-related information guarantee apparatus 500 structurally includes at least a CPU 501, a memory 502, a storage device 503, and a communication interface 504. The communication interface 504 is, for example, a wired LAN card, a wireless LAN card, or the like and communicates with the notification apparatus 300 and the intermediary notification apparatus 400 via the communication channel 600. The storage device 503 is, for example, one that stores programs and data and more specifically a hard disk drive, a flash memory, or the like. The programs above are read by the memory 502 and executed by the CPU 501, thereby performing particular tasks.

In the system configuration above of FIG. 1, it is assumed that the owner-information management apparatus 200 is possessed by a retailer; however, this assumption is only meant to be an example. Any business entities including repair shops, movers, and the like can have the owner-information management apparatus 200 as long as they need to manage product owner information based on item IDs. In addition, such a business entity can have multiple owner-information management apparatuses 200 (e.g., one owner-information management apparatus 200 in each place of business).

Further, in the system configuration above of FIG. 1, it is also assumed that the notification apparatus 300 is possessed by a manufacturer, which is also meant to be an example. Any business entities can have the notification apparatus 300 as long as they need to notify the purchasers of their products of certain information. In addition, such a business entity can have multiple notification apparatuses 300 (e.g., one notification apparatus 300 in each place of business).

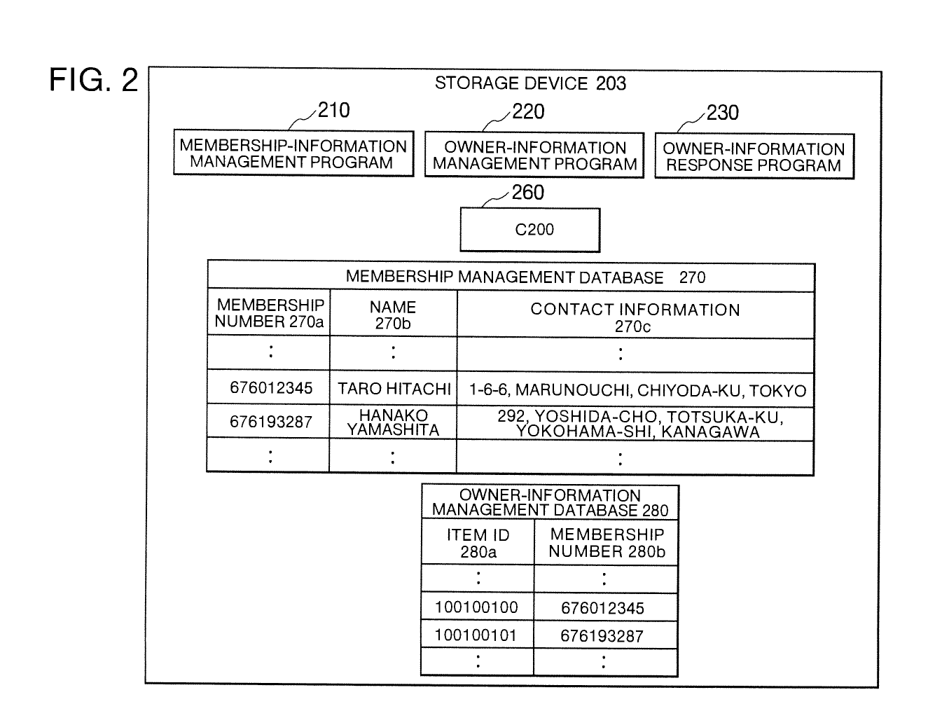

FIG. 2 is a diagram illustrating the configuration of the storage device 203 that is included in an owner-information management apparatus 200 possessed by a retailer. The storage device 203 of the owner-information management apparatus 200 includes, as its programs, at least a membership-information management program 210, an owner-information management program 220, and an owner-information response program 230 and also includes, as its data, at least a retailer code 260, a membership management database 270, and an owner-information management database 280.

The retailer code 260 is the unique code that identifies the retailer. The retailer code 260 is input by, for example, an input device (not illustrated) of the owner-information management apparatus 200.

The membership management database 270 is a collection of data used to manage the membership of the retailer. The membership management database 270 includes, as its data fields, at least Membership Number 270a, Member Name 270b, and Contact Information 270c.

The column of Membership Number 270a of FIG. 2 is data fields that allow the input of the unique membership numbers that identify individual members.

The column of Member Name 270b is data fields that allow the input of the names of the members.

The column of Contact Information 270c is data fields that allow the input of the contact information of the members such as addresses, phone numbers, e-mail addresses, and the like.

The owner-information management database 280 is a collection of data used to manage information on members who purchased products from the retailer. The owner-information management database 280 includes, as its data fields, at least Item ID 280a and Membership Number 280b.

The column of Item ID 280a is data fields that allow the input of the item IDs 100 of the products members purchased.

The column of Membership Number 280b is data fields that allow the input of the membership numbers of the members who purchased the products assigned the item IDs 100.

The membership-information management program 210 is a program used to register information on the membership of the retailer in the membership management database 270 and refer to the information registered in the membership management database 270 at a later time. The registration of the membership information in the membership management database 270 by the membership-information management program 210 is prompted by the membership information being input by, for example, an input device (not illustrated) of the owner-information management apparatus 200.

The owner-information management program 220 is a program used to register the membership numbers of members who purchased products from the retailer in the owner-information management database 280 and refer to the information registered in the owner-information management database 280 at a later time. The registration of the membership numbers in the owner-information management database 280 by the owner-information management program 220 is prompted by the item IDs of the products being input by a barcode reader, a two-dimensional-code reader, an RFID reader, or the like (not illustrated) of the owner-information management apparatus 200 or prompted by the membership numbers (and/or membership-related information) stored on their membership cards (not illustrated) being input by a reader (not illustrated) of the owner-information management apparatus 200. In this case, instead of the membership numbers, other information can also be used as long as it can identify the members.

The owner-information response program 230 is a program that responds with information on members who purchased products with particular item IDs, or owner information, upon receipt of a request from the intermediary notification apparatus 400.

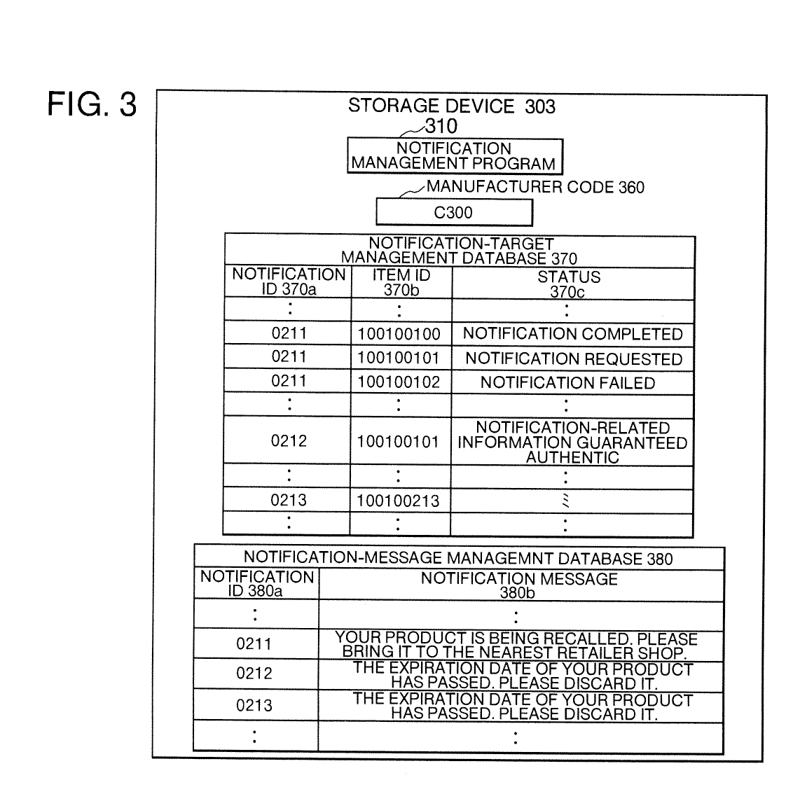

FIG. 3 is a diagram illustrating the configuration of the storage device 303 that is included in a notification apparatus 300 possessed by a manufacturer. The storage device 303 of the notification apparatus 300 includes, as its program, at least a notification management program 310 and also includes, as its data, at least a manufacturer code 360, a notification-target management database 370, and a notification-message management database 380.

The manufacturer code 360 is the unique code that identifies the manufacturer. The manufacturer code 360 is input by, for example, an input device (not illustrated) of the notification apparatus 300.

The notification-target management database 370 is a collection of data used to manage the products, among those sold to retailers, that require their owners to be notified of certain information and manage the notification status of the products. The notification-target management database 370 includes, as its data fields, at least Notification ID 370a, Item ID 370b, and Status 370c. Notification targets (product owners who need notification) are managed based on notification messages or the notification IDs that identify the messages.

The column of Notification ID 370a of FIG. 3 is data fields that allow the input of notification IDs that identify individual notification messages.

The column of Item ID 370b is data fields that allow the input of the item IDs of the products that require their owners to be notified of the notification messages that correspond to the notification IDs 370a.

The column of Status 370c is data fields that allow the input of the notification status of the products that correspond to the Item ID 370b and require their owners to be notified of the notification messages that correspond to the notification IDs 370a. More specifically, when a new record is added, the symbol “-” is set. When the content of the record is guaranteed authentic by the notification-related information guarantee apparatus 500, the phrase “notification-related information guaranteed authentic” is set. When the notification apparatus 300 requests the intermediary notification apparatus 400 to act as an intermediary in notifying product owners, the phrase “notification requested” is set. When the notification is complete, the phrase “notification completed” is set. If the notification is unsuccessful, the phrase “notification failed” is set.

The notification-message management database 380 is a collection of data used to manage notification messages that need to be communicated to the owners of particular products. The notification-message management database 380 includes, as its data fields, at least Notification ID 380a and Notification Message 380b.

The column of Notification ID 380a is data fields that allow the input of the notification IDs that identify individual notification messages.

The column of Notification Message 380b is data fields that allow the input of the notification messages that correspond to the notification IDs 380a.

The notification management program 310 is a program used to register, refer to, and modify notification-related information in the notification-target management database 370 and the notification-message management database 380 and also used to request the notification-related information guarantee apparatus 500 to guarantee the authenticity of the notification-related information for the purpose of notifying product owners of particular information and to request the intermediary notification apparatus 400 to act as an intermediary in notifying the product owners. The registration of the notification-related information (notification targets and notification messages) in the notification-target management database 370 and the notification-message management database 380 by the notification management program 310 is prompted by the notification-related information being input by, for example, an input device (not illustrated) of the notification apparatus 300.

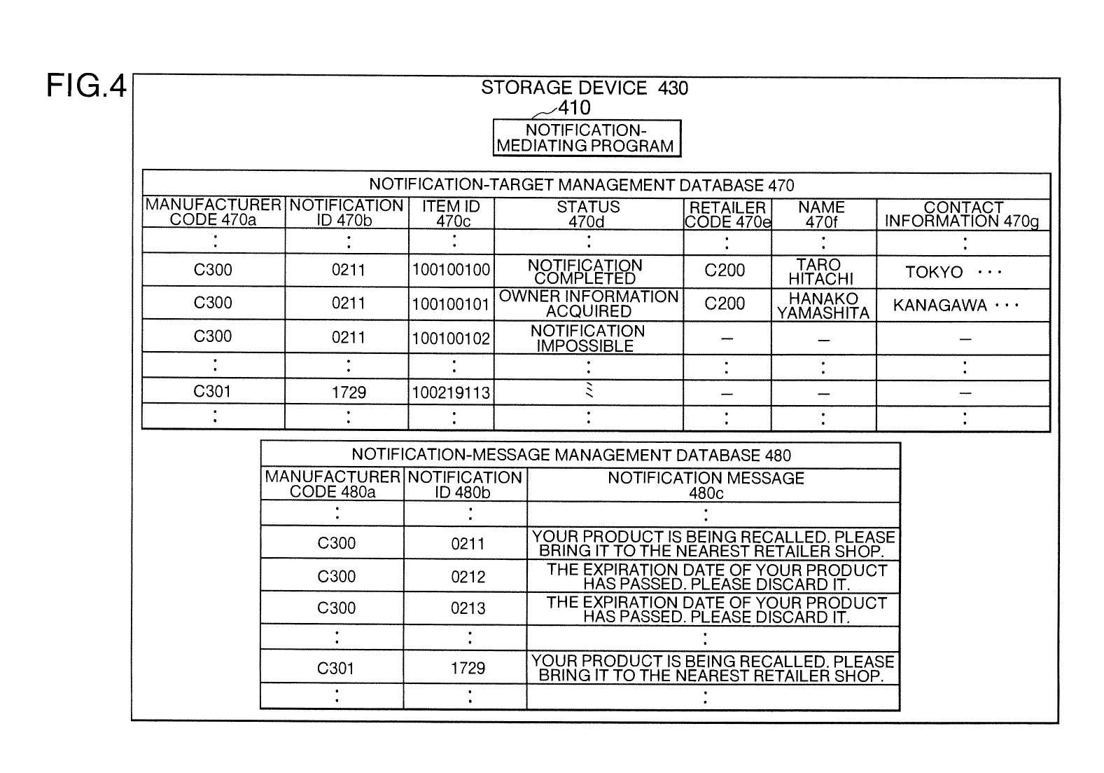

FIG. 4 is a diagram illustrating the configuration of the storage device 403 that is included in the intermediary notification apparatus 400. The storage device 403 of the intermediary notification apparatus 400 includes, as its program, at least a notification-mediating program 410 and also includes, as its data, at least a notification-target management database 470 and a notification-message management database 480.

The notification-target management database 470 is a collection of data used to manage the notification targets guaranteed authentic by the notification-related information guarantee apparatus 500 (targets for which the intermediary notification apparatus 400 acts as a notification intermediary) among those for which multiple notification apparatuses 300 requested the intermediary notification apparatus 400 to mediate notification and also used to manage the notification mediation status of each notification target. The notification-target management database 470 includes, as its data fields, at least Manufacturer Code 470a, Notification ID 470b, Item ID 470c, Status 470d, Retailer Code 470e, Owner Name 470f, and Contact Information 470g.

The column of Manufacturer Code 470a is data fields that allow the input of the manufacturer codes that identify the manufacturers (notification apparatuses 300) that requested mediation of owner notification.

The column of Notification ID 470b is data fields that allow the input of the notification IDs that identify the notification messages for which the manufacturers (notification apparatuses 300) corresponding to the manufacturer codes 470a requested mediation of owner notification.

The column of Item ID 470c is data fields that allow the input of the item IDs of the products that require their owners to be notified of the notification messages that correspond to the notification IDs 470b.

The column of Status 470d is data fields that allow the input of the notification status of the product owners corresponding to the item IDs 470c. The notification status is a status of notifying the notification messages that correspond to combinations of the manufacturer codes 470a and the notification IDs 470b. More specifically, when a new record is added, the symbol “-” is set. When the owner information corresponding to the item ID 470c of that record is acquired and registered from an owner-information management apparatus 200, the phrase “owner information acquired” is set. If not, the phrase “notification impossible” is set. When the owner of the product corresponding to the item ID 470c of the record is successfully notified, the phrase “notification complete” is set. If the notification is unsuccessful, the phrase “notification failed” is set.

The column of Retailer Code 470e is data fields that allow the input of the retailer codes that identify the retailers (owner-information management apparatuses 200) that possess the owner information corresponding to the item IDs 470c.

The column of Owner Name 470f is data fields that allow the input of the names of the product owners corresponding to the item IDs 470c, which names are provided by the retailers (owner-information management apparatuses 200) corresponding to the retailer codes 470e.

The column of Contact Information 470g is data fields that allow the input of the contact information of the product owners corresponding to the item IDs 470c, which information is provided by the retailers (owner-information management apparatuses 200) corresponding to the retailer codes 470e.

The notification-message management database 480 is a collection of data used to manage the notification messages guaranteed authentic by the notification-related information guarantee apparatus 500 (messages that the intermediary notification apparatus 400 is to communicate as a notification intermediary) among those for which multiple notification apparatuses 300 requested the intermediary notification apparatus 400 to mediate notification. The notification-message management database 480 includes, as its data fields, at least Manufacturer Code 480a, Notification ID 480b, and Notification Message 480c.

The column of Manufacturer Code 480a is data fields that allow the input of the manufacturer codes that identify the manufacturers (notification apparatuses 300) that requested mediation of owner notification.

The column of Notification ID 480b is data fields that allow the input of the notification IDs that identify the notification messages for which the manufacturers (notification apparatuses 300) corresponding to the manufacturer codes 480a requested mediation of owner notification.

The column of Notification Message 480c is data fields that allow the input of the notification messages corresponding to combinations of the manufacturer codes 480a and the notification IDs 480b.

While registering, referring to, and modifying notification-related information in the notification-target management database 470 and the notification-message management database 480, the notification-mediating program 410 mediates owner notification by requesting, upon receipt of a request from a notification apparatus 300, the notification-related information guarantee apparatus 500 to verify the notification-related information included in that request and by acquiring the owner information from an owner-information management apparatus(es) 200.

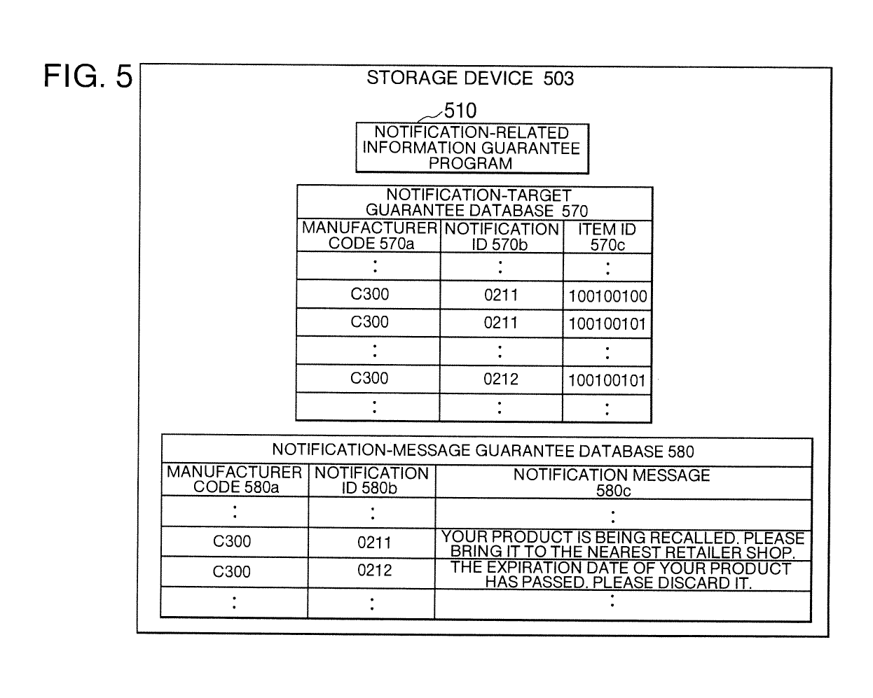

FIG. 5 is a diagram illustrating the configuration of the storage device 503 that is included in the notification-related information guarantee apparatus 500. The storage device 503 of the notification-related information guarantee apparatus 500 includes, as its program, at least a notification-related information guarantee program 510 and also includes, as its data, at least a notification-target guarantee database 570 and a notification-message guarantee database 580.

The notification-target guarantee database 570 is a collection of data used to manage the notification targets that can be guaranteed authentic among notification-related information (notification targets and notification messages) included in requests from notification apparatuses 300. The notification-target guarantee database 570 includes, as its data fields, at least Manufacturer Code 570a, Notification ID 570b, and Item ID 570c.

The column of Manufacturer Code 570a is data fields that allow the input of the manufacturer codes that identify the manufacturers (notification apparatuses 300) that requested the notification-related information guarantee apparatus 500 to guarantee the authenticity of notification-related information.

The column of Notification ID 570b is data fields that allow the input of the notification IDs that identify the notification messages for which the manufacturers (notification apparatuses 300) corresponding to the manufacturer codes 570a requested the notification-related information guarantee apparatus 500 to guarantee the authenticity of notification-related information.

The column of Item ID 570c is data fields that allow the input of the item IDs of the products that require their owners to be notified of the notification messages that correspond to the notification IDs 570b.

The notification-message guarantee database 580 is a collection of data used to manage the notification messages that can be guaranteed authentic among notification-related information (notification targets and notification messages) included in requests from notification apparatuses 300. The notification-message guarantee database 580 includes, as its data fields, at least Manufacturer Code 580a, Notification ID 580b, and Notification Message 580c.

The column of Manufacturer Code 580a is data fields that allow the input of the manufacturer codes that identify the manufacturers (notification apparatuses 300) that requested the notification-related information guarantee apparatus 500 to guarantee the authenticity of notification-related information.

The column of Notification ID 580b is data fields that allow the input of the notification IDs that identify the notification messages for which the manufacturers (notification apparatuses 300) corresponding to the manufacturer codes 580a requested the notification-related information guarantee apparatus 500 to guarantee the authenticity of notification-related information.

The column of Notification Message 580c is data fields that allow the input of the notification messages that correspond to combinations of the manufacturer codes 580a and the notification IDs 580b.

While registering and referring to notification-related information in the notification-target guarantee database 570 and the notification-message guarantee database 580, the notification-related information guarantee program 510 guarantees the authenticity of the notification-related information included in a request from a notification apparatus 300 and also verifies the notification-related information included in a request from the intermediary notification apparatus 400 and responds with the result.

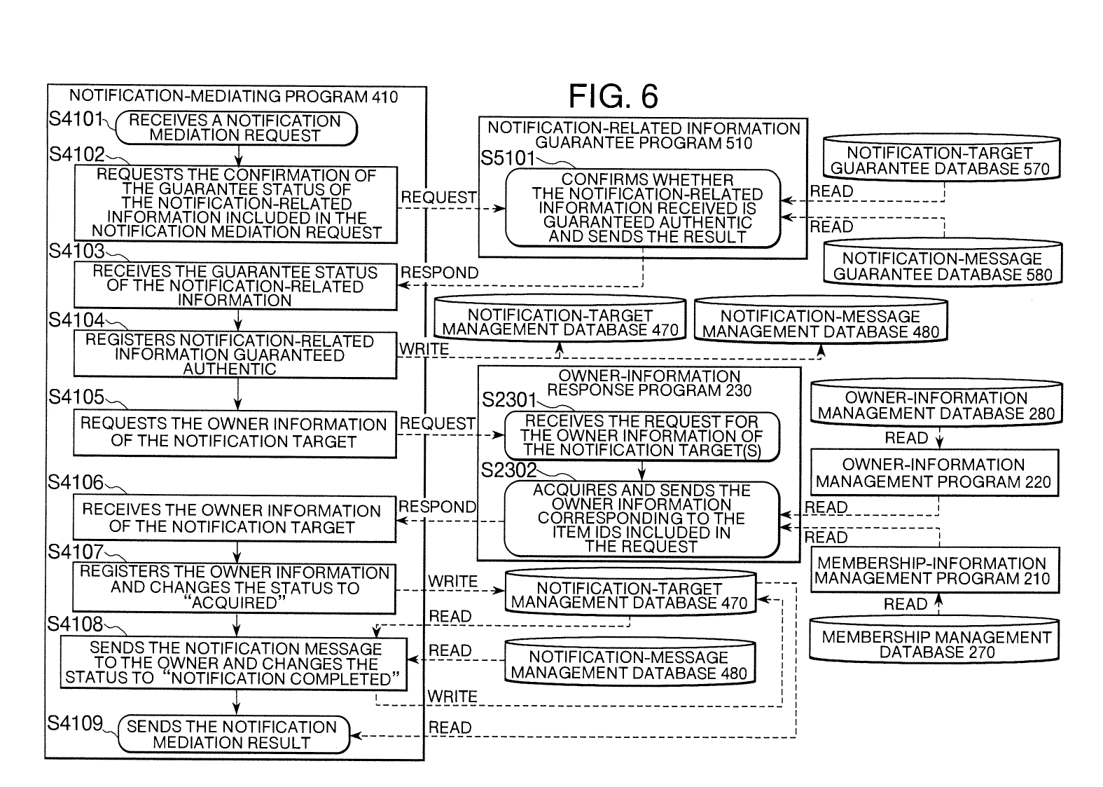

FIG. 6 is a flowchart illustrating the process flows of notification mediation operation, notification-related-information guarantee-status response operation, and owner-information response operation. In accordance with this flowchart, the notification-mediating program 410 performs the notification mediation operation, the notification-related information guarantee program 510 performs the notification-related-information guarantee-status response operation, and the owner-information response program 230 of an owner-information management apparatus 200 performs the owner-information response operation. More specifically, the notification-mediating program 410 performs the steps of receiving a request from the notification management program 310 of a notification apparatus 300; requesting the notification-related information guarantee program 510 to verify the notification-related information included in the request; acquiring from the owner-information response program 230 the owner information of the products that correspond to the item IDs included in the request; acting as an intermediary in notifying the owners of the notification message included in the request with the use of the acquired owner information; and transmitting the result to the notification management program 310. The notification-related information guarantee program 510 performs the steps of receiving a request from the notification-mediating program 410; verifying the notification-related information included in the request; and transmitting the result to the notification-mediating program 410. The owner-information response program 230 performs the steps of receiving a request from the notification-mediating program 410 and transmitting to the notification-mediating program 410 information on the members or owners who purchased the products with the item IDs specified by the request.

The process of FIG. 6 starts with the notification-mediating program 410's receipt of a notification mediation request from the notification management program 310 of a notification apparatus 300 (Step S4101). The notification mediation request includes the manufacturer code of the manufacturer (notification apparatus 300) that possesses the notification management program 310 and also includes notification-related information, a collection of information necessary for the manufacturer to request mediation of owner notification. The notification-related information includes a notification message; the notification ID that identifies the message; and the item IDs of the products that require their owners to be notified of the message (at the very least, one item ID).

After Step S4101, the notification-mediating program 410 transmits the manufacturer code and the notification-related information, both included in the notification mediation request, to the notification-related information guarantee program 510, thereby requesting the notification-related information guarantee program 510 to confirm whether the notification-related information of the manufacturer (notification apparatus 300) corresponding to the manufacturer code has been guaranteed authentic by the notification-related information guarantee apparatus 500 (Step S4102).

After receiving the confirmation request, the notification-related information guarantee program 510 searches the notification-target guarantee database 570 for records that have the same manufacturer code 570a as the manufacturer code above, the same notification ID 570b as the notification ID included in the notification-related information above, and the same item IDs 570c as the item IDs included in the notification-related information above. The notification-related information guarantee program 510 also searches the notification-message guarantee database 580 for a record that has the same manufacturer code 580a as the manufacturer code above, the same notification ID 580b as the notification ID included in the notification-related information above, and the same notification message 580c as the notification message included in the notification-related information above. The notification-related information guarantee program 510 then transmits the result to the notification-mediating program 410, the result being either “guaranteed authentic” when completely matched records have been found (meaning that at least one record has been found in the notification-target guarantee database 570 and one record has been found in the notification-message guarantee database 580) or “not guaranteed authentic” when such a record has not been found (Step S5101).

After receiving the result, the notification-mediating program 410 terminates the process if the result is “not guaranteed authentic” or continues the process if the result is “guaranteed authentic” (Step S4103). In the case of the continuation of the process, the notification-mediating program 410 registers in the notification-target management database 470 records that have the same manufacturer code 470a as the manufacturer code above, the same notification ID 470b as the notification ID included in the notification-related information above, and the same item IDs 470c as the item IDs included in the notification-related information above and also have the symbol “-” in the data fields of Status 470d, Retailer Code 470e, Owner Name 470f, and Contact Information 470g. The notification-mediating program 410 also registers in the notification-message management database 480 a record that has the same manufacturer code 480a as the manufacturer code above, the same notification ID 480b as the notification ID included in the notification-related information above, and the same notification message 480c as the notification message included in the notification-related information above (Step S4104).

Then, the notification-mediating program 410 transmits the item IDs 470c registered in the notification-target management database 470 in Step S4104 to the owner-information response programs 230 of all the owner-information management apparatuses 200, thereby requesting the owner information that corresponds to the item IDs 470c (Step S4105).

After the owner-information response programs 230 receive the owner-information request (Step S2301), each of them searches its owner-information management database 280 via its owner-information management program 220 for records that have the same item IDs 280a as the item IDs 470c received. When such records have been found, each of the owner-information response programs 230 then searches its membership management database 270 via its membership-information management program 210 for records that have the same membership numbers 270a as the membership numbers 280b included in the found records. Thereafter, each of the owner-information response programs 230 transmits the following information to the notification-mediating program 410 (Step S2302): the same item IDs 280a as the item IDs 470c received; the owner names 270b and the contact information 270c included in the found records in the membership management database 270; and the retailer code of the retailer (owner-information management apparatus 200) which is obtained by the owner-information response program 230 referring to the retailer code 260. It should be noted that each of the owner-information response programs 230 is designed to accept requests only from the notification-mediating program 410 of the intermediary notification apparatus 400.

After receiving the owner information above (Step S4106), the notification-mediating program 410 performs data input operation on the records in the notification-target management database 470 that have the same item IDs 470c as the item IDs 280a received. Specifically, the status 470d of the records is changed from the symbol “-” to “owner information acquired”; the retailer codes 470e of the records are changed from the symbol “-” to the retailer codes received; the owner names 470f of the records are changed from the symbol “-” to the owner names 270b received; and the contact information 470g of the records is changed from the symbol “-” to the contact information 270c received (Step S4107). Note that if the notification-mediating program 410 has yet to receive, from any owner-information response program 230, any response to the item IDs 470c the notification-mediating program 410 transmitted to all the owner-information response programs 230 in Step S4105 even after the passage of a predetermined amount of time (e.g., one day), the status 470d of the records in the notification-target management database 470 that correspond to the item IDs 470c is changed from the symbol “-” to “notification impossible.”

After Step S4107, the notification-mediating program 410 searches the records registered in the notification-target management database 470 in Step S4104 for records with the status 470d indicative of “owner information acquired.” When such records are found, the notification-mediating program 410 notifies the owners in the found records, which have data in the data fields of Owner Name 470f and Contact Information 470g, of the notification message 480c of the records in the notification-message management database 480 that have the same notification IDs 480b as the notification IDs 470b in the records found in the notification-target management database 470. When the notification is successful, the status 470d of the records found in the notification-target management database 470 is changed from “owner information acquired” to “notification completed”; if not, to “notification impossible” (Step S4108). Examples of notification methods include e-mails, telephone calls, and postcards when the contact information 470g is an e-mail address, a phone number, or an address, respectively. If notification with such means is unsuccessful, the status 470d is changed to “notification impossible.” A possible method for inputting “notification impossible” is through an input device (not illustrated) of the intermediary notification apparatus 400 or the like.

After Step S4108, the notification-mediating program 410 refers to all the records registered in the notification-target management database 470 in Step S4104 and transmits to the notification management program 310 data sets consisting of the data that lies in the data fields of Notification ID 470b, Item ID 470c, and Status 470d of the records above (Step S4109). In this case, the notification-mediating program 410 determines which notification management program 310 to respond to with the use of the manufacturer code included in the notification mediation request received in Step S4101 and with reference to a table (not illustrated in FIG. 4) of the storage device 403 in which manufacturer codes are correlated with the addresses of notification apparatuses 300. The process of FIG. 6 ends with Step S4109.

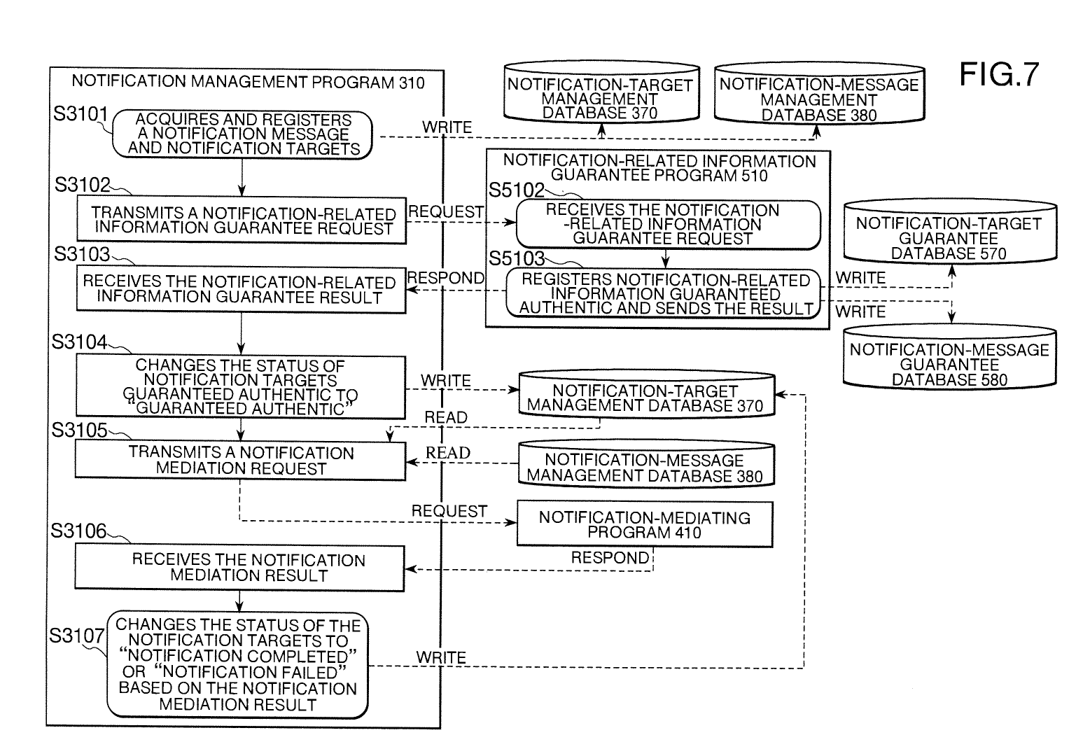

FIG. 7 is a flowchart illustrating the process flows of notification operation, and notification-related-information guarantee operation. In accordance with this flowchart, the notification management program 310 of a notification apparatus 300 performs the notification operation, and the notification-related information guarantee program 510 performs the notification-related-information guarantee operation. More specifically, for the purpose of notifying the owners who purchased particular products indirectly from the manufacturer of particular information, the notification management program 310 requests the notification-related information guarantee program 510 to verify notification-related information and requests the notification-mediating program 410 to act as an intermediary in notifying the owners. The notification-related information guarantee program 510 receives the request from the notification management program 310 and guarantees the authenticity of the notification-related information included in the request.

The process of FIG. 7 starts with the input of a notification message and notification targets to the notification management program 310 of a notification apparatus 300 through an input device (not illustrated) of the notification apparatus 300. The notification message is the message that needs to be communicated to the owners of particular products. The notification targets are the item IDs of the products that require their owners to be notified of the notification message. Next, the notification management program 310 creates a record in the notification-message management database 380 by registering a unique notification ID in a data field of Notification ID 380a and the notification message above in a data field of Notification Message 380b. The notification management program 310 also creates records (one record when a single notification target is input to the notification management program 310) in the notification-target management database 370 by registering the notification ID 380a above in data fields of Notification ID 370a, the item IDs above in the data fields of Item ID 370b, the symbol “-” in the data fields of Status 370c (Step S3101). A possible method for creating a unique notification ID in a data field of Notification ID 380a is to separately store the notification ID created last and increment the last notification ID by, for example, one, thereby creating a new, unique notification ID.

Then, the notification management program 310 transmits to the notification-related information guarantee program 510 the notification ID and notification message registered in the notification-message management database 380, all the item IDs registered in the notification-target management database 370 in Step S3101, and the manufacturer code 360 of the manufacturer (notification apparatus 300), which transmits a notification-related information guarantee request (Step S3102). The notification-related information guarantee request is a request for the notification-related information guarantee apparatus 500 to guarantee that the notification-related information (the notification message and the notification targets) included in the notification-related information guarantee request has been received from nothing other than the manufacturer (notification apparatus 300).

After receiving the notification-related information guarantee request from the notification management program 310 (Step S5102), the notification-related information guarantee program 510 verifies whether the notification-related information guarantee request has been received from nothing other than the manufacturer (notification apparatus 300) that corresponds to the manufacturer code included in the request. If the notification-related information guarantee program 510 verifies that is so, it then creates a record in the notification-message guarantee database 580 by registering the manufacturer code of the manufacturer in a data field of Manufacturer Code 580a, the notification ID included in the notification-related information guarantee request in a data field of Notification ID 570b, and the notification message included in the notification-related information guarantee request in a data field of Notification Message 570c. The notification-related information guarantee program 510 also creates records (one record when a single notification target is included in the notification-related information guarantee request) in the notification-target guarantee database 570 by registering the manufacturer code above in data fields of Manufacturer Code 570a, the notification ID included in the notification-related information guarantee request in data fields of Notification ID 570b, and the item IDs included in the notification-related information guarantee request in data fields of Item ID 570c and then transmits the result “notification-related information guaranteed authentic” to the notification management program 310. If, on the other hand, the notification-related information guarantee program 510 cannot verify that the notification-related information guarantee request has been received from nothing other than the manufacturer (notification apparatus 300) that corresponds to the manufacturer code included in the request, then, the notification-related information guarantee program 510 transmits the result “notification-related information not guaranteed authentic” to the notification management program 310 (Step S5103).

After receiving the result, the notification management program 310 terminates the process if the result is “not guaranteed authentic” or continues the process if the result is “guaranteed authentic” (Step S3103). In the case of the continuation of the process, the notification management program 310 searches the notification-target management database 370 for the records with the same notification ID 370a as the notification ID created and registered in Step S3101 and changes the status 370c of the found records from the symbol “-” to “notification-related information guaranteed authentic” (Step S3104).

The notification management program 310 also searches the notification-message management database 380 for the record with the same notification ID 380a as the notification ID created and registered in Step S3101 and searches the notification-target management database 370 for the records with the same notification ID 370a as the notification ID created and registered in Step S3101. The notification management program 310 then transmits to the notification-mediating program 410 the notification message 380b included in the record found in the notification-message management database 380, the item IDs 370b included in the records found in the notification-target management database 370, the notification ID mentioned above, and the manufacturer code 360 of the manufacturer (notification apparatus 300), thereby transmitting a notification mediation request to the notification-mediating program 410 (Step S3105).

Step S3105 initiates the process of FIG. 6.

With reference back to FIG. 7, when the notification management program 310 receives from the notification-mediating program 410 the notification mediation result, that is, data sets consisting of the data that lies in the data fields of Notification ID 470b, Item ID 470c, and Status 470d in the notification-target management database 470 (at least one data set) (Step S3106), the notification management program 310 changes the status 370c of the records in the notification-target management database 370 that have the same notification ID 370a as the notification ID 470b and the same item IDs 370b as the item IDs 470c to “notification completed” or “notification impossible” based on the status 470d (Step S3107). This ends the process of FIG. 7.

While the preferred embodiments of the invention have been discussed in detail, the invention is not limited thereto but embraces various modifications within the scope thereof.

For instance, in the aforementioned preferred embodiments of the invention, the intermediary notification apparatus 400 is designed to request the notification-related information guarantee apparatus 500 to verify the notification-related information included in a request from a notification apparatus 300. However, if the notification apparatus 300 (manufacturer) is reliable as an information source, the verification process by the notification-related information guarantee apparatus 500 can be omitted. In this case, the intermediary notification apparatus 400 may create and manage a list of the manufacturer codes of reliable notification apparatuses 300 (manufacturers), thereby judging whether to request the verification by the notification-related information guarantee apparatus 500. When the verification process by the notification-related information guarantee apparatus 500 can be omitted, Steps S4102, S5101, and S4103 of FIG. 6 can be skipped. If a notification apparatus 300 (manufacturer) is reliable to the intermediary notification apparatus 400, Steps S3102, S5102, S5103, and S3103 of FIG. 7 can also be skipped. Further, if the intermediary notification apparatus 400 is designed to trust all the notification apparatuses 300 (manufacturers), the notification-related information guarantee apparatus 500 is not necessary.

In the aforementioned preferred embodiments of the invention, only one notification-related information guarantee apparatus 500 is provided for each system, but multiple notification-related information guarantee apparatuses 500 can instead be provided for each. For example, a possible case would be one in which Manufacturer A requests Notification-Related Information Guarantee Apparatus B to guarantee the authenticity of notification-related information while Manufacturer C requests Notification-Related Information Guarantee Apparatus D to do so. Another would be one in which Manufacturers A and C make such requests to Notification-Related Information Guarantee Apparatus E for the purpose of notifying the owners of home-electronics and to Notification-Related Information Guarantee Apparatus F for the purpose of notifying the owners of automobiles. In such cases, during Step S3105 of FIG. 7, the notification management program 310 of a notification apparatus 300 should include, in a notification mediation request to the notification-mediating program 410, the address (or code) of a notification-related information guarantee apparatus 500 that has guaranteed the authenticity of the notification-related information from the notification management program 310. By so doing, during Step S4101 of FIG. 6, the notification-mediating program 410 can acquire the address of the notification-related information guarantee apparatus from the notification mediation request (or acquire the code of the notification-related information guarantee apparatus 500 and convert the code to the address of the notification-related information guarantee apparatus 500), thereby allowing the notification-mediating program 410 to determine which notification-related information guarantee apparatus 500 the notification-mediating program 410 should make a request to for the purpose of the confirmation of the notification-related information guarantee status.

1. An information providing method involving the use of a notification apparatus employed by a notifier to notify the owners of items of item-related information, a plurality of service provider apparatuses employed by a plurality of service providers who provide item-related services for the owners, and an intermediary apparatus that acts as an intermediary in the notification, the method comprising the steps of:
the plurality of service provider apparatuses each storing on a storage device contact information that includes in a paired manner the item IDs of items read with the use of a reader upon service provision and the contact addresses or contact numbers of the owners of the items and transmitting the contact information to the intermediary apparatus;
the intermediary apparatus receiving the contact information from the plurality of service provider apparatuses and storing the received contact information on the storage device;
the notification apparatus transmitting, to the intermediary apparatus, information that requests contact information that includes particular item IDs specified by the notification apparatus; and
the intermediary apparatus searching the contact information stored on the storage device of the intermediary apparatus for the contact information that includes the particular item IDs specified by the notification apparatus, thereby notifying the owners of the items with the particular item IDs of item-related information with the use of the contact information found.

2. The information providing method defined in claim 1:
wherein the intermediary apparatus and the notification apparatus are both connected to a notification-information guarantee apparatus that guarantees the authenticity of the contact information; and
the notification-information guarantee apparatus receives the contact information from the plurality of service provider apparatuses, verifies the authenticity of the contact information received, and transmits the contact information received to the intermediary apparatus only when the authenticity of the contact information is guaranteed.

3. The information providing method defined in claim 1, wherein upon receipt from the intermediary apparatus of information that requests the contact information, the plurality of service provider apparatuses transmit the contact information to the intermediary apparatus.

4. The information providing method defined in claim 3, wherein the plurality of service provider apparatuses receive, from the intermediary apparatus, information that includes particular item IDs and requests the contact information and transmit, to the intermediary apparatus, contact information that corresponds to the particular item IDs received.

5. The information providing method defined in claim 1, wherein the plurality of service provider apparatuses transmit the contact information to the intermediary apparatus at particular time intervals.

6. The information providing method defined in claim 1, wherein the contact information includes information that indicates the destination addresses of the owners, and the intermediary apparatus transmits item-related information to the destination addresses.

7. The information providing method defined in claim 1, wherein the contact information includes information that indicates the domiciles of the owners, and the intermediary apparatus displays the domiciles.

8. An information providing system, comprising:
a notification apparatus employed by a notifier to notify the owners of items of item-related information;
a plurality of service provider apparatuses employed by a plurality of service providers who provide item-related services for the owners; and
an intermediary apparatus that acts as an intermediary in the notification,
wherein:
the plurality of service provider apparatuses each store on a storage device contact information that includes in a paired manner the item IDs of items read with the use of a reader upon service provision and the contact addresses or contact numbers of the owners of the items and transmit the contact information to the intermediary apparatus;
the intermediary apparatus receives the contact information from the plurality of service provider apparatuses and stores the received contact information on the storage device;
the notification apparatus transmits, to the intermediary apparatus, information that requests contact information that includes particular item IDs specified by the notification apparatus; and
the intermediary apparatus searches the contact information stored on the storage device of the intermediary apparatus for the contact information that includes the particular item IDs specified by the notification apparatus, thereby notifying the owners of the items with the particular item IDs of item-related information with the use of the contact information found.

9. The information providing system defined in claim 8, further comprising:
a notification-information guarantee apparatus for guaranteeing the authenticity of the contact information,
wherein the notification-information guarantee apparatus receives the contact information from the plurality of service provider apparatuses, verifies the authenticity of the contact information received, and transmits the contact information received to the intermediary apparatus only when the authenticity of the contact information is guaranteed.

10. The information providing system defined in claim 8, wherein upon receipt from the intermediary apparatus of information that requests the contact information, the plurality of service provider apparatuses transmit the contact information to the intermediary apparatus.

11. The information providing system defined in claim 10, wherein the plurality of service provider apparatuses receive, from the intermediary apparatus, information that includes particular item IDs and requests the contact information and transmit, to the intermediary apparatus, contact information that corresponds to the particular item IDs received.

12. The information providing system defined in claim 8, wherein the plurality of service provider apparatuses transmit the contact information to the intermediary apparatus at particular time intervals.

13. The information providing system defined in claim 8, wherein the contact information includes information that indicates the destination addresses of the owners, and the intermediary apparatus transmits item-related information to the destination addresses.

14. The information providing system defined in claim 8, wherein the contact information includes information that indicates the domiciles of the owners, and the intermediary apparatus displays the domiciles.

15. The information providing system defined in claim 8, wherein the plurality of service provider apparatuses are employed at least either at outlets that sell the items as the services or at repair shops that at least either repair the items or accept repair of the items as the services.
